(19) United States
(12) Patent Application Publication
(10) Pub. No.: US 2007/0127728 A1
(43) Pub. Date: Jun. 7, 2007

(54) Iterative decoding apparatus and method

(75) Inventors: Jin-sook Hong, Suwon-si (KR); Hyun-jung Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/602,994

(22) Filed: Nov. 22, 2006

(30) Foreign Application Priority Data
Nov. 25, 2005 (KR) 2005-113493

(51) Int. Cl. H04R 5/00

(52) U.S. Cl. 381/18

(57) ABSTRACT

An iterative decoding apparatus includes a channel detection unit receiving an input signal derived from an output signal of a channel and detecting a channel signal from the input signal by using a soft value; a channel decoding unit receiving the detected channel signal from the channel detection unit and decoding the detected channel signal by using a soft value; a pseudo-channel block unit receiving the decoded channel signal from the channel decoding unit and adding a channel effect to the decoded channel signal to obtain a channel-effect-added signal; and a signal mixing unit mixing the channel-effect-added signal from the pseudo-channel block unit with the output signal of the channel to obtain the input signal and providing the input signal to the channel detection unit.

### CROSS-REFERENCE TO RELATED APPLICATION

This application claims the benefit of Korean Patent Application No. 2005-113493 filed on Nov. 25, 2005, in the Korean Intellectual Property Office, the disclosure of which is incorporated herein by reference in its entirety.

### BACKGROUND OF THE INVENTION

1. Field of the Invention

An aspect of the invention relates to iterative decoding, and more particularly, to an iterative decoding apparatus and method capable of implementing an iterative decoder through the addition of a simple circuit.

2. Description of the Related Art

A high-speed communication system and a high-density information storage apparatus should effectively compensate for intersymbol interference and white noise. To achieve this, commercial receivers and magnetic and optical storage apparatuses have typically used a partial response maximum likelihood (PRML) detector as a channel detector, and a Reed-Solomon (RS) code as a channel decoder code. However, since increases in the speed of the communication system and the density of the information storage apparatus have increased the length of the intersymbol interference, and thus have lowered the performance, a new approach, such as a turbo equalizer shown in FIG. 1, has been required.

Referring to FIG. 1, a receiver system of the related art includes a channel encoder 110, a partial response (PR) channel 215, a channel detector 150, and a channel decoder 160. The PR channel 115 is modeled by a channel 120, a mixing unit 130 that adds noise to the system, and an equalizer 140.

A turbo equalizer is constituted by the channel encoder 110 tuned to PR channel 215 and the channel decoder 150. The channel detector 150 receives the output of the PR channel 115 and a prior probability from the channel decoder 160, and uses a soft-in-soft-out (SISO) algorithm to generate an additional probability. The channel decoder 160 uses this additional probability in decoding the channel signal, and thus an error in the channel signal is corrected. The channel decoder 160 outputs this additional probability as a prior probability to the channel detector 150.

In particular, the channel detector 150 uses a modified soft output Viterbi algorithm (SOVA) or a Bahl, Cocke, Jelinek, and Raviv (BCJR) algorithm (also known as a maximum aposteriori probability (MAP) algorithm) that is an improvement over the Viterbi algorithm and is capable of producing a soft output. The channel decoder 160 receives the output of the channel detector 150 and uses low-density parity-check (LDPC) codes that provide excellent performance approaching within 0.0045 dB of the Shannon limit.

The system shown in FIG. 1 uses the channel detector 150 and the channel decoder 160 to iteratively exchange information between different codes to thereby improve the performance of the entire system.

The channel detector 150 and the channel decoder 160 combine reliability information of a channel signal output from a previous stage and generate channel detection and/or decoding reliability information and additional reliability information.

Furthermore, the additional reliability information is provided to a next stage. That is, the channel detector 150 provides the additional reliability information to the channel decoder 160, and the channel decoder 160 provides the additional reliability information to the channel detector 150 as prior reliability information.

Thus, most detectors and decoders based on probability are based on a theory that the result of decoding can be distinguished as prior reliability information and additional reliability information, and this iterative decoding further improves the performance.

However, in order to implement this iterative decoding, a legacy detector and a legacy decoder should be redesigned to be SISO types to be adaptable to the iterative decoding.

### SUMMARY OF THE INVENTION

An aspect of the invention provides an iterative decoding apparatus and method capable of implementing an iterative decoder through the addition of a simple circuit.

According to an aspect of the invention, an iterative decoding apparatus includes a channel detection unit receiving an input signal derived from an output signal of a channel and detecting a channel signal from the input signal by using a soft value; a channel decoding unit receiving the detected channel signal from the channel detection unit and decoding the detected channel signal by using a soft value; a pseudo-channel block unit receiving the decoded channel signal from the channel decoding unit and adding a channel effect to the decoded channel signal to obtain a channel-effect-added signal; and a signal mixing unit mixing the channel-effect-added signal from the pseudo-channel block unit with the output signal of the channel to obtain the input signal and providing the input signal to the channel detection unit.

The channel detection unit may include a soft output Viterbi algorithm (SOVA) detector, and the channel decoding unit may include a low-density parity-check (LDPC) decoder.

The decoded channel signal received by the pseudo-channel block unit may comprise a soft output or a hard output.

The signal mixing unit may apply a first weight value to the channel-effect-added signal from the pseudo-channel block unit to obtain a first weighted signal, apply a second weight value to the output signal of the channel to obtain a second weighted signal, and add the first weighted signal to the second weighted signal to obtain the input signal.

According to another aspect of the invention, an iterative decoding method includes receiving an input signal derived from an output signal of a channel; detecting a channel signal from the input signal by using a soft value; decoding the detected channel signal by using a soft value; adding a channel effect to the decoded channel signal to obtain a channel-effect-added signal; and mixing the channel-effect-added signal with the output signal of the channel to obtain the input signal.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a block diagram of a receiver system employing a turbo equalizer according to the related art;

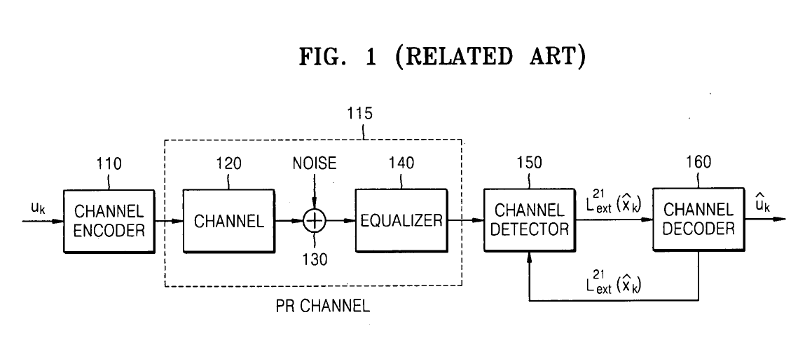

FIG. 2 is block diagram of a receiver system according to an aspect of the invention;

FIG. 3 is a flowchart of a method of iterative decoding according to an aspect of the invention;

FIG. 4 is a graph of the performance of a method using (200,100) LDPC coding according to an aspect of the invention; and

FIG. 5 is a graph of the performance of a method using (1400,700) LDPC coding according to an aspect of the invention.

### DETAILED DESCRIPTION OF THE EMBODIMENTS

Reference will now be made in detail to embodiments of the invention, examples of which are shown in the accompanying drawings, wherein like elements refer to like elements throughout. The embodiments are described below in order to explain the invention by referring to the figures.

A system according to an aspect of the invention further improves performance by adding a pseudo-channel block unit and a signal mixing unit to an existing system using a soft output Viterbi algorithm (SOVA) detector and a low-density parity-check (LDPC) decoder without changing the internal structure of the existing system. The existing system is currently being studied in the high-density optical recording device field.

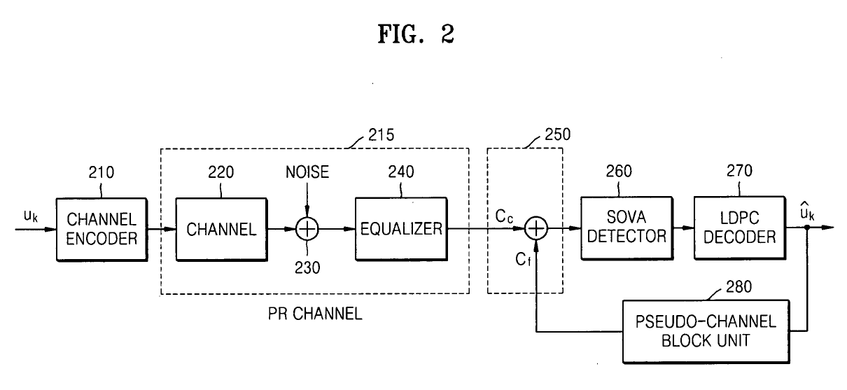

FIG. 2 is a receiver system according to an aspect of the invention. Referring to FIG. 2, the receiver system includes a channel encoder 210, a partial response (PR) channel 215, a signal mixing unit 250, a SOVA detector 260, an LDPC decoder 270, and a pseudo-channel block unit 280. The PR channel 215 is modeled by a channel 220, a mixing unit 230 that adds noise to the system, and an equalizer 240.

The channel encoder 210 receives an input signal uₖ, encodes the input signal uₖ using an LDPC code to obtain an encoded signal, and outputs the encoded signal to the PR channel 215. The PR channel 215 produces an output signal that is the encoded signal output from the channel encoder 210 distorted by characteristics of the PR channel and mixed with the noise added by the mixing unit 230. The signal mixing unit 250 mixes the output signal of the PR channel 215 with a channel-effect-added signal that is output from the pseudo-channel block unit 280 to obtain an input signal, and outputs the input signal to the SOVA detector 260. The SOVA detector 260 detects a channel signal from the input signal that is output from the signal mixing unit 250 to obtain a detected channel signal, and outputs the detected channel signal to the LDPC decoder 270. The LDPC decoder 270 decodes the detected channel signal that is output from the SOVA detector 260 to obtain a decoded channel signal ûₖ which is a reconstruction of the input signal uₖ of the channel encoder 210, and outputs the decoded channel signal ûₖ for use in a desired application. The decoded channel signal ûₖ that is output from the LDPC decoder 270 is also input to the pseudo-channel block unit 280, which outputs a channel-effect-added signal that simulates the effect of the decoded channel signal ûₖ passing through the PR channel 215. The channel-effect-added signal that is output from the pseudo-channel block unit 280 is input to the signal mixing unit 250.

The input signal ûₖ of the channel encoder 210 may be a data signal that is to be transmitted over a communication channel, in which case the PR channel 215 corresponds to the communication channel, and the decoded channel signal ûₖ that is output from the LDPC decoder 270 is a received data signal that is a reconstruction of the transmitted data signal.

Alternatively, the input signal uₖ of the channel encoder 210 may be a data signal that is to be recorded on a magnetic or optical recording medium, in which case the PR channel 215 corresponds to a recording and reproducing apparatus that records the encoded signal output from the channel encoder 210 on the recording medium and reproduces the recorded encoded signal from the recording medium as the output signal of the PR channel 215, and the decoded channel signal ûₖ that is output from the LDPC decoder 270 is a reproduced data signal that is a reconstruction of the input signal uₖ. The recording medium may be any magnetic or optical recording medium, but the invention is particularly suited for use with a high-density recording medium, such as a high-density magnetic recording medium, such as a vertical or perpendicular magnetic recording medium, or a high-density optical recording medium, such as a DVD optical disc, a Blu-ray optical disc, or an HD DVD optical disc.

Although the channel encoder 210 using an LDPC code, the SOVA detector 260, and the LDPC decoder 270 are used in the system shown in FIG. 2, the invention is not limited to these particular elements. The channel encoder 210 can be replaced by any channel encoder using any suitable code, the SOVA detector 260 can be replaced by any channel detector capable of processing a soft value, and the LDPC decoder 270 can be replaced by any channel decoder capable of processing a soft value.

The pseudo-channel block unit 280 makes a codeword estimated in the LDPC decoder 270 correspond to the PR channel 215. The signal mixing unit 250 applies a weight value Cc to the output of the PR channel 215 and a weight value Cf to the output of the pseudo-channel block unit 280, and adds the two resulting weighted outputs to obtain the input of the SOVA detector 260. A probability distribution in which the sum of the weight values is 1 (i.e., Cc +Cf=1=100%) is assumed

As discussed above, the pseudo-channel block unit 280 receives the decoded channel signal ûₖ that is output from the LDPC decoder 270, and outputs a channel-effect-added signal that simulates the effect of the decoded channel signal ûₖ passing through the PR channel 215. This is necessary because the input of the SOVA detector 260 is derived in part from the output of the PR channel 215 which is produced by the encoded signal that is output from the channel encoder 210 passing through the PR channel 215. The pseudo-channel block unit 280 provides a soft output that directly uses a log likelihood ratio (LLR) reliability that is an output of the LDPC decoder 270, and a hard output that uses a discrete value obtained by determining the soft output. If the model coefficients of the PR channel 215 are I₀, I₁, . . . Iᵢ₋₁, the outputs of the pseudo-channel block unit 280 are defined as follows:

Hard output:

$${\hat{y}}_{i} = {\sum }_{k = 0}^{t - 1} {I}_{k} {\hat{u}}_{i - k}$$

(where ûᵢ₋ₖ indicates a transmission terminal bitstream)

Soft output:

$${\hat{y}}_{i} = {\sum }_{y ∈ \{ {\sum }_{k = 0}^{t - 1} {I}_{k} {x}_{i - k} \vert {x}_{i - k} ∈ {F}_{2} \}} y {\prod }_{k = 0}^{t - 1} Pr \{ {\hat{u}}_{i - k} = {x}_{i - k} \}$$

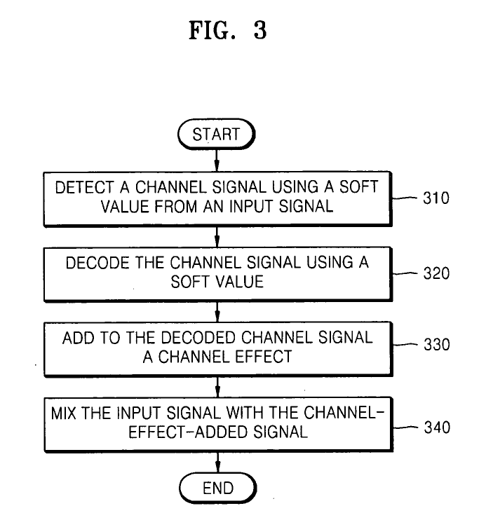

FIG. 3 is a flowchart of a method of iterative decoding according to an aspect of the invention. Referring to FIG. 3, an input signal is received from a channel and a channel signal is detected using a soft value in operation 310. In order to detect the channel signal, a SOVA detector can be used, for example.

The channel signal is decoded using a soft value in operation 320. In order to decode the channel signal, an LDPC decoder can be used, for example. The decoded channel signal can be a hard output or a soft output.

A channel effect is added to the decoded channel signal in operation 330.

The channel-effect-added signal is mixed with the input signal in operation 340. Here, a first weight value may be applied to the channel-effect-added signal and a second weight value may be applied to the input signal.

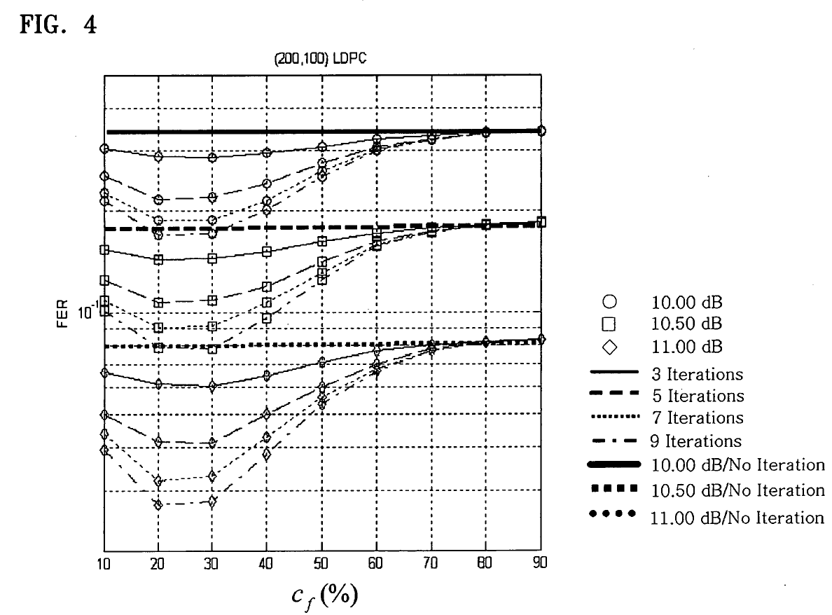

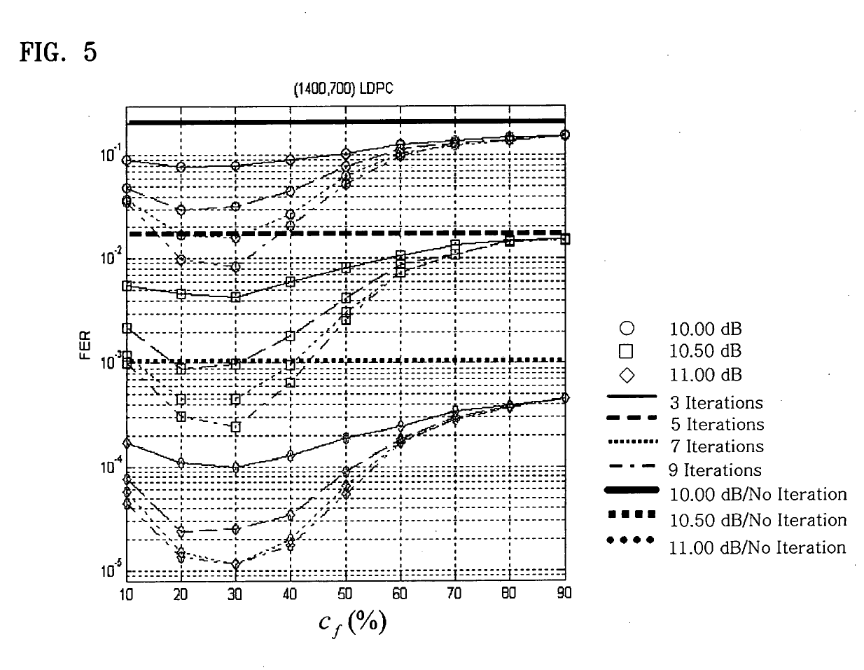

If an apparatus and a method are provided as described above, an improvement of an iterative correction effect in accordance with an increase in a length of an LDPC codeword and a signal mixing ratio can be obtained as shown in FIGS. 4 and 5.

Referring to FIGS. 4 and 5, it can be seen that with an increasing length of the LDPC codeword, and with a predetermined signal mixing ratio, that is, when Cf in FIG. 2 is about 20-30%, the correction performance improves with an increasing number of iterations.

Referring to FIGS. 4 and 5, the vertical axis indicates a frame error rate (FER) and the horizontal axis indicates the weight value Cf applied to the output of the pseudo-channel block unit 280 in FIG. 2, that is, a signal mixing ratio.

FIG. 4 is a graph of a case where an LDPC codeword has the format (200, 100) (where 200 is the length of the codeword in bits, and 100 is the length of information in bits), and FIG. 5 is a graph of a case where the format of the LDPC codeword is (1400,700). Generally, in the case of the LDPC codeword, as the length of the LDPC codeword increases, the performance improves. Accordingly, it can be seen that the performance shown in FIG. 5 is better than the performance shown in FIG. 4.

Referring to FIGS. 4 and 5, since a dB value is an index related to white noise, and if this value increases, the performance improves, the highest dB value of 11 dB appears the lowest in the graph.

Also, FIGS. 4 and 5 show that as the number of iterations increases, the FER decreases and the performance improves.

Furthermore, when there is no iteration, there is no change in the performance as Cf changes, and the performance appears as a straight line, e.g., the straight lines corresponding to 10 dB, 10.5 dB, and 11 dB shown in FIGS. 4 and 5.

Since the channel environment in which intersymbol interference becomes serious relates to optical or magnetic recording devices as well as high-speed communication systems, if the system according to an aspect of the invention is employed, the correction effect can be improved.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. An iterative decoding apparatus comprising:
a channel detection unit receiving an input signal derived from an output signal of a channel and detecting a channel signal from the input signal by using a soft value;
a channel decoding unit receiving the detected channel signal from the channel detection unit and decoding the detected channel signal by using a soft value;
a pseudo-channel block unit receiving the decoded channel signal from the channel decoding unit and adding a channel effect to the decoded channel signal to obtain a channel-effect-added signal; and
a signal mixing unit mixing the channel-effect-added signal from the pseudo-channel block unit with the output signal of the channel to obtain the input signal and providing the input signal to the channel detection unit.

2. The apparatus of claim 1, wherein the channel detection unit comprises a soft output Viterbi algorithm (SOVA) detector; and
wherein the channel decoding unit comprises a low-density parity-check (LDPC) decoder.

3. The apparatus of claim 1, wherein the decoded channel signal received by the pseudo-channel block unit comprises a soft output or a hard output.

4. The apparatus of claim 3, wherein the soft output is defined as follows:
$${\hat{y}}_{i} = {\sum }_{y ∈ \{ {\sum }_{k = 0}^{t - 1} {I}_{k} {x}_{i - k} \vert {x}_{i - k} ∈ {F}_{2} \}} y {\prod }_{k = 0}^{t - 1} Pr \{ {\hat{u}}_{i - k} = {x}_{i - k} \} .$$

5. The apparatus of claim 3, wherein the hard output is defined as follows:
$${\hat{y}}_{i} = {\sum }_{k = 0}^{t - 1} {I}_{k} {\hat{u}}_{i - k}$$
(where ûᵢ₋ₖ indicates a transmission terminal bitstream).

6. The apparatus of claim 1, wherein the signal mixing unit applies a first weight value to the channel-effect-added signal from the pseudo-channel block unit to obtain a first weighted signal, applies a second weight value to the output signal of the channel to obtain a second weighted signal, and adds the first weighted signal to the second weighted signal to obtain the input signal.

7. The apparatus of claim 1, wherein parameters of the pseudo-channel block unit are the same as parameters of the channel.

8. An iterative decoding method comprising:
receiving an input signal derived from an output signal of a channel;
detecting a channel signal from the input signal by using a soft value;
decoding the detected channel signal by using a soft value;
adding a channel effect to the decoded channel signal to obtain a channel-effect-added signal; and
mixing the channel-effect-added signal with the output signal of the channel to obtain the input signal.

9. The method of claim 8, wherein the detecting of the channel signal comprises detecting the channel signal using a soft output Viterbi algorithm (SOVA) algorithm; and
wherein the decoding of the detected channel signal comprises decoding the channel signal based on a low-density parity check (LDPC) code.

10. The method of claim 8, wherein the decoded channel signal comprises a soft output or a hard output.

11. The method of claim 10, wherein the soft output is defined as follows:
$${\hat{y}}_{i} = {\sum }_{y ∈ \{ {\sum }_{k = 0}^{t - 1} {I}_{k} {x}_{i - k} \vert {x}_{i - k} ∈ {F}_{2} \}} y {\prod }_{k = 0}^{t - 1} Pr \{ {\hat{u}}_{i - k} = {x}_{i - k} \} .$$

12. The method of claim 10, wherein the hard output is defined as follows:
$${\hat{y}}_{i} = {\sum }_{k = 0}^{t - 1} {I}_{k} {\hat{u}}_{i - k}$$
(where ûᵢ₋ₖ indicates a transmission terminal bitstream).

13. The method of claim 8, wherein the mixing of the channel-effect-added signal with the output signal of the channel comprises:
applying a first weight value to the channel-effect-added signal to obtain a first weighted signal;
applying a second weight value to the input signal to obtain a second weighted signal; and
adding the first weighted signal to the second weighted signal to obtain the input signal.

14. The method of claim 8, wherein the adding of a channel effect is performed based on parameters of the channel.
